(19) United States
(12) Patent Application Publication
(10) Pub. No.: US 2022/0305471 A1
(43) Pub. Date: Sep. 29, 2022

(54) MOLECULAR SIEVE SSZ-92, CATALYST, AND METHODS OF USE THEREOF

(71) Applicant: CHEVRON U.S.A. INC., San Ramon, CA (US)

(72) Inventors: Adeola Florence OJO, Pleasant Hill, CA (US); Yihua ZHANG, Albany, CA (US); Guan-Dao LEI, Walnut Creek, CA (US); Howard S. LACHEEN, Richmond, CA (US)

(21) Appl. No.: 17/214,782

(22) Filed: Mar. 26, 2021

(51) Int. Cl. B01J 29/80; B01J 29/74; B01J 37/04; B01J 37/03; C10G 45/64

(52) U.S. Cl. CPC B01J 29/80; B01J 29/7461; B01J 29/7446; B01J 29/74; B01J 37/04; B01J 37/031; C10G 45/64; B01J 2029/062

(57) ABSTRACT

The present application pertains to family of new crystalline molecular sieves designated SSZ-92. Molecular sieve SSZ-92 is structurally similar to sieves falling within the ZSM-48 family of molecular sieves and is characterized as having magnesium.

### TECHNICAL FIELD

The present disclosure relates to catalysts having an MRE type structure with magnesium oxide referred to as molecular sieve SSZ-92 and methods of use thereof.

### BACKGROUND AND SUMMARY

A hydroisomerization catalytic dewaxing process for the production of base oils from a hydrocarbon feedstock involves introducing the feed into a reactor containing a dewaxing catalyst system with the presence of hydrogen. Within the reactor, the feed contacts the hydroisomerization catalyst under hydroisomerization dewaxing conditions to provide an isomerized stream. Hydroisomerization removes aromatics and residual nitrogen and sulfur and isomerize the normal paraffins to improve the base oil cold properties. The isomerized stream may be further contacted in a second reactor with a hydrofinishing catalyst to remove traces of any aromatics, olefins, improve color, and the like from the base oil product. The hydrofinishing unit may include a hydrofinishing catalyst comprising an alumina support and a noble metal, typically palladium, or platinum in combination with palladium.

The challenges generally faced in typical hydroisomerization catalytic dewaxing processes include, among others, providing product(s) that meet pertinent product specifications, such as cloud point, pour point, viscosity and/or viscosity index limits for one or more products, while also maintaining good product yield. In addition, further upgrading, e.g., during hydrofinishing, to further improve product quality may be used, e.g., for color and oxidation stability by saturating aromatics to reduce the aromatics content. The presence of residual organic sulfur and nitrogen from upstream hydrotreatment and hydrocracking processes, however, may have a significant impact on downstream processes and final base oil product quality.

Dewaxing of straight chain paraffins involves a number of hydroconversion reactions, including hydroisomerization, redistribution of branches, and secondary hydroisomerization. Consecutive hydroisomerization reactions lead to an increased degree of branching accompanied by a redistribution of branches. Increased branching generally increases the probability of chain cracking, leading to greater fuels yield and a loss of base oil/lube yield. Minimizing such reactions, including the formation of hydroisomerization transition species, can therefore lead to increased base oil/lube yield.

A more robust catalyst for base oil/lube production is therefore needed to isomerize wax molecules and provide improved base oil/lube product properties by reducing undesired cracking and hydroisomerization reactions. Accordingly, a continuing need exists for catalysts, catalyst systems, and processes to produce base oil/lube products, while also providing good base oil/lube product properties and product yield.

Advantageously, the present application pertains in one embodiment to a molecular sieve belonging to the ZSM-48 family of zeolites. The molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium. The molecular sieve has a morphology characterized as polycrystalline aggregates comprising crystallites collectively having an average aspect ratio of between 1 and 8.

In another embodiment the present application pertains to a process for converting hydrocarbons. The process comprises contacting a hydrocarbonaceous feed under hydrocarbon converting conditions with a catalyst comprising a molecular sieve belonging to the ZSM-48 family of zeolites. The molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium. The molecular sieve has a morphology characterized as polycrystalline aggregates comprising crystallites collectively having an average aspect ratio of between 1 and 8. Advantageously, the process may provide one or more of the following: better selectivity, improved lube yields, improved viscosity index, and/or improved gas make (less gas).

Further features of the disclosed molecular sieve and the advantages offered thereby are explained in greater detail hereinafter with reference to specific example embodiments illustrated in the accompanying drawings.

### BRIEF DESCRIPTION OF THE DRAWINGS

FIG. 1 depicts an XRD powder diffraction of an SSZ-91 catalyst without magnesium oxide.

FIG. 2 depicts an XRD powder diffraction of an SSZ-92 catalyst with magnesium oxide.

FIG. 3 depicts an SEM of an SSZ-92 catalyst with magnesium oxide.

FIG. 4 depicts an XRD powder diffraction of an SSZ-92 catalyst with magnesium oxide.

FIG. 5 depicts an SEM of an SSZ-92 catalyst with magnesium oxide.

FIG. 6 depicts a TEM of an ammonium exchanged zeolite SSZ-92.

FIG. 7 depicts an NH₃ TPD profile for Examples 1, 2, and 3.

FIG. 8 depicts FTIR spectra for Examples 1, 2, and 3.

FIG. 9 depicts ATR-IR spectra for Examples 1, 2, and 3.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“API gravity” refers to the gravity of a petroleum feedstock or product relative to water, as determined by ASTM D4052-11.

“Viscosity index” (VI) represents the temperature dependency of a lubricant, as determined by ASTM D2270-10(E2011).

“Vacuum gas oil” (VGO) is a byproduct of crude oil vacuum distillation that can be sent to a hydroprocessing unit or to an aromatic extraction for upgrading into base oils. VGO generally comprises hydrocarbons with a boiling range distribution between 343° C. (649 ° F.) and 593° C. (1100 ° F.) at 0.101 MPa.

“Treatment,” “treated,” “upgrade,” “upgrading” and “upgraded,” when used in conjunction with an oil feedstock, describes a feedstock that is being or has been subjected to hydroprocessing, or a resulting material or crude product, having a reduction in the molecular weight of the feedstock, a reduction in the boiling point range of the feedstock, a reduction in the concentration of asphaltenes, a reduction in the concentration of hydrocarbon free radicals, and/or a reduction in the quantity of impurities, such as sulfur, nitrogen, oxygen, halides, and metals.

“Hydroprocessing” refers to a process in which a carbonaceous feedstock is brought into contact with hydrogen and a catalyst, at a higher temperature and pressure, for the purpose of removing undesirable impurities and/or converting the feedstock to a desired product. Examples of hydroprocessing processes include hydrocracking, hydrotreating, catalytic dewaxing, and hydrofinishing.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

“Hydrotreating” refers to a process that converts sulfur and/or nitrogen-containing hydrocarbon feeds into hydrocarbon products with reduced sulfur and/or nitrogen content, typically in conjunction with hydrocracking, and which generates hydrogen sulfide and/or ammonia (respectively) as byproducts. Such processes or steps performed in the presence of hydrogen include hydrodesulfurization, hydrodenitrogenation, hydrodemetallation, and/or hydrodearomatization of components (e.g., impurities) of a hydrocarbon feedstock, and/or for the hydrogenation of unsaturated compounds in the feedstock. Depending on the type of hydrotreating and the reaction conditions, products of hydrotreating processes may have improved viscosities, viscosity indices, saturates content, low temperature properties, volatilities and depolarization, for example. The terms “guard layer” and “guard bed” may be used herein synonymously and interchangeably to refer to a hydrotreating catalyst or hydrotreating catalyst layer. The guard layer may be a component of a catalyst system for hydrocarbon dewaxing, and may be disposed upstream from at least one hydroisomerization catalyst.

“Catalytic dewaxing”, or hydroisomerization, refers to a process in which normal paraffins are isomerized to their more branched counterparts by contact with a catalyst in the presence of hydrogen.

“Hydrofinishing” refers to a process that is intended to improve the oxidation stability, UV stability, and appearance of the hydrofinished product by removing traces of aromatics, olefins, color bodies, and solvents. UV stability refers to the stability of the hydrocarbon being tested when exposed to UV light and oxygen. Instability is indicated when a visible precipitate forms, usually seen as Hoc or cloudiness, or a darker color develops upon exposure to ultraviolet light and air. A general description of hydrofinishing may be found in U.S. Pat. Nos. 3,852,207 and 4,673,487.

The term “Hydrogen” or “hydrogen” refers to hydrogen itself, and/or a compound or compounds that provide a source of hydrogen.

“Cut point” refers to the temperature on a True Boiling Point (TBP) curve at which a predetermined degree of separation is reached.

“Pour point” refers to the temperature at which an oil will begin to flow under controlled conditions. The pour point may be determined by, for example, ASTM D5950.

“Cloud point” refers to the temperature at which a lube base oil sample begins to develop a haze as the oil is cooled under specified conditions. The cloud point of a lube base oil is complementary to its pour point. Cloud point may be determined by, for example, ASTM D5773.

“TBP” refers to the boiling point of a hydrocarbonaceous feed or product, as determined by Simulated Distillation (SimDist) by ASTM D2887-13.

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

The term “Periodic Table” refers to the version of the IUPAC Periodic Table of the Elements dated Jun. 22, 2007, and the numbering scheme for the Periodic Table Groups is as described in Chem. Eng. News, 63(5), 26-27 (1985). “Group 2” refers to IUPAC Group 2 elements, e.g., magnesium, (Mg), Calcium (Ca), Strontium (Sr), Barium (Ba) and combinations thereof in any of their elemental, compound, or ionic form. “Group 6” refers to IUPAC Group 6 elements, e.g., chromium (Cr), molybdenum (Mo), and tungsten (W). “Group 7” refers to IUPAC Group 7 elements, e.g., manganese (Mn), rhenium (Re) and combinations thereof in any of their elemental, compound, or ionic form. “Group 8” refers to IUPAC Group 8 elements, e.g., iron (Fe), ruthenium (Ru), osmium (Os) and combinations thereof in any of their elemental, compound, or ionic form. “Group 9” refers to IUPAC Group 9 elements, e.g., cobalt (Co), rhodium (Rh), iridium (Ir) and combinations thereof in any of their elemental, compound, or ionic form. “Group 10” refers to IUPAC Group 10 elements, e.g., nickel (Ni), palladium (Pd), platinum (Pt) and combinations thereof in any of their elemental, compound, or ionic form. “Group 14” refers to IUPAC Group 14 elements, e.g., germanium (Ge), tin (Sn), lead (Pb) and combinations thereof in any of their elemental, compound, or ionic form.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. The term “molecular sieve” and “zeolite” are synonymous and include (a) intermediate and (b) final or target molecular sieves and molecular sieves produced by (1) direct synthesis or (2) post-crystallization treatment (secondary modification). Secondary synthesis techniques allow for the synthesis of a target material from an intermediate material by heteroatom lattice substitution or other techniques. For example, an aluminosilicate can be synthesized from an intermediate borosilicate by post- crystallization heteroatom lattice substitution of the Al for B. Such techniques are known, for example as described in U.S. Pat. No. 6,790,433. Zeolites, crystalline aluminophosphates and crystalline silicoaluminophosphates are representative examples of molecular sieves.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

In one aspect, the present invention is a hydroisomerization catalyst system, useful to make dewaxed products including base/lube oils, the catalyst comprising a catalyst composition comprising an SSZ-92 molecular sieve. The catalyst composition may be arranged in conjunction with other catalysts such that a hydrocarbon feedstock may be sequentially contacted with either the hydroisomerization catalyst composition first to provide a first product followed by contacting the first product with the other catalyst composition(s) to provide a second product, or with the other catalyst composition(s) first followed by contacting one or more product streams from such other catalysts with the hydroisomerization catalyst. The hydroisomerization catalyst composition generally comprises an SSZ-92 molecular sieve, along with other components, including, e.g., matrix (support) materials and at least one modifier selected from Groups 6 to 10 and Group 14 of the Periodic Table and magnesium.

In a further aspect, the present invention concerns a hydroisomerization process, useful to make dewaxed products including base oils, the process comprising contacting a hydrocarbon feedstock with the hydroisomerization catalyst system under hydroisomerization conditions to produce a base oil product or product stream. As noted, the feedstock may be first contacted with the hydroisomerization catalyst composition to provide a first product followed by contacting the first product with one or more other catalyst compositions as needed to produce a second product, or may be first contacted with such other catalyst compositions as needed, followed by contacting one or more product streams from such catalyst compositions with the hydroisomerization catalyst. The first and/or second products from such arrangements may themselves be a base oil product, or may be used to make a base oil product. SSZ-92 Molecular Sieves Comprising Magnesium

The SSZ-92 molecular sieve used herein is made in a similar manner to SSZ-91 except that SSZ- 92 comprises magnesium, preferably as part of the reaction mixture as opposed to impregnated after molecular sieve formation. The SSZ-91 molecular sieve and processes are described in, e.g., U.S. 201700568681; U.S. Pat. Nos. 9,802,830; 9,920,260; 10,618,816; and in WO2017/034823 all of which are incorporated herein by reference. The SSZ-91 and SSZ-92 molecular sieve generally comprises ZSM-48 type zeolite material, the molecular sieve having at least 70% polytype 6 of the total ZSM-48-type material; an EUO-type phase in an amount of between 0 and 3.5 percent by weight; and polycrystalline aggregate morphology comprising crystallites having an average aspect ratio of between 1 and 8. The silicon oxide to aluminum oxide mole ratio of the SSZ-92 molecular sieve may be in the range of 40 to 220 or 50 to 220 or 40 to 200. In some cases, the SSZ-92 molecular sieve may have at least 70% polytype 6 of the total ZSM-48- type material; an EUO-type phase in an amount of between 0 and 3.5 percent by weight; and polycrystalline aggregate morphology comprising crystallites having an average aspect ratio of between 1 and 8. In some cases, the SSZ-92 material is composed of at least 70%, or at least 90% polytype 6 of the total ZSM-48-type material present in the product. The polytype 6 structure has been given the framework code *MRE by the Structure Commission of the International Zeolite Association. The term “*MRE-type molecular sieve” and “EUO-type molecular sieve” includes all molecular sieves and their isotypes that have been assigned the International Zeolite Association framework, as described in the Atlas of Zeolite Framework Types, eds. Ch. Baerlocher, L.B. Mccusker and D.H. Olson, Elsevier, 6th revised edition, 2007 and the Database of Zeolite Structures on the International Zeolite Association's website (http://www.iza- online.org). The molecular sieve generally has a morphology characterized as polycrystalline aggregates comprising crystallites collectively having an average aspect ratio of between 1 and 8. Magnesium Amounts and Addition

As described above, the primary difference between SSZ-92 and SSZ-91 is that SSZ-92 comprises magnesium. The magnesium may be added at any convenient point during the process of making the molecular sieve. In some embodiments, magnesium oxide is added to the reaction mixture for forming the molecular sieve although other sources of magnesium may be employed. Other magnesium sources include, for example, a magnesium salts or salts such as magnesium nitrate, magnesium chloride, magnesium sulfate, mixed magnesium and calcium salts, and/or any mixture or combination thereof. The source of magnesium is not critical so long as magnesium becomes part of the molecular sieve to afford it the desired properties. For example, magnesium salts such as magnesium nitrate, sulfate, chloride and even mixed magnesium and calcium salts may be employed.

The amount of magnesium may vary depending upon the desired selectivity, conversion, and/or base oil properties such as lube yield, viscosity index, gas make, and the like.

In some embodiments, the molecular sieve comprises a magnesium oxide to silicon dioxide ratio of at least about 0.005, or at least about 0.01, or at least about 0.04, or at least about 0.05 up to about 0.4, or up to about 0.25, or up to about 0.22, or up to about 0.2. SSZ-92 Reaction Mixture Components

Typical and preferred molar ratios for reaction mixture components are described in the table below. The mixtures are heated, stirred, filtered, washed, and dried as described in the SSZ-91 references incorporated by reference above and the examples described below. That is, suitable methods may comprise: (a) preparing a reaction mixture containing: at least one source of silicon, at least one source of aluminum, at least one source of an element selected from Groups 1 and 2 of the Periodic Table, at least one source of magnesium, hydroxide ions, hexamethonium cations, and water; and (b) subjecting the reaction mixture to crystallization conditions sufficient to form crystals of the molecular sieve. Suitable reaction mixtures are below. M is selected from Groups 1 and 2 of the Periodic Table and Q is a hexamethonium cation.

| | Typical | Preferred |
|---|---|---|
| Components | molar ratio | molar ratio |
| SiO₂/Al₂O₃ | 50-220 | 70-180 |
| M/SiO₂ | 0.05-1.0 | 0.1-0.4 |
| MgO/SiO₂ | 0.005-0.4 | 0.01-0.25 |
| Q/SiO₂ | 0.01-0.1 | 0.015-0.05 |
| OH/SiO₂ | 0.05-0.4 | 0.10-0.3 |
| H₂O/SiO₂ | 3.0-100 | 10-40 |

In some embodiments the molecular sieve further comprises palladium, platinum, or a mixture thereof. The molecular sieve may have more ammonia desorbing above 440° C. than a comparable molecular sieve lacking magnesium in an ammonia temperature programmed desorption test such as the one described below. In some cases, the molecular sieve exhibits an FTIR vibrational mode at 3670 cm⁻¹ before exposure to pyridine, after exposure to pyridine, or both.

### Matrix and Modifiers

The SSZ-92 molecular sieves of the catalyst composition is generally combined with a matrix material to form a base material. The base material may, e.g., be formed as a base extrudate by combining the molecular sieve with the matrix material, extruding the mixture to form shaped extrudates, followed by drying and calcining of the extrudate. The catalyst composition also typically further comprises at least one modifier selected from Groups 6 to 10 and Group 14, and optionally further comprising a Group 2 metal, of the Periodic Table. Modifiers may be added through the use of impregnation solutions comprising modifier compounds.

Suitable matrix materials for the catalyst composition include alumina, silica, ceria, titania, tungsten oxide, zirconia, or a combination thereof. In some embodiments, aluminas for the catalyst compositions and the process may also be a “high nanopore volume” alumina, abbreviated as “HNPV” alumina, as described in U.S. application Ser. No. 17/095,010, filed on Nov. 11, 2020, herein incorporated by reference. Suitable aluminas are commercially available, including, e.g., Catapal® aluminas and Pural® aluminas from Sasol or Versal® aluminas from UOP. In general, the alumina can be any alumina known for use as a matrix material in a catalyst base. For example, the alumina can be boehmite, bayerite, y-alumina, η-alumina, θ-alumina, δ-alumina, x-alumina, or a mixture thereof.

Suitable modifiers are selected from Groups 6-10 and Group 14 of the Periodic Table (IUPAC). Suitable Group 6 modifiers include Group 6 elements, e.g., chromium (Cr), molybdenum (Mo), and tungsten (W) and combinations thereof in any of their elemental, compound, or ionic form. Suitable Group 7 modifiers include Group 7 elements, e.g., manganese (Mn), rhenium (Re) and combinations thereof in any of their elemental, compound, or ionic form. Suitable Group 8 modifiers include Group 8 elements, e.g., iron (Fe), ruthenium (Ru), osmium (Os) and combinations thereof in any of their elemental, compound, or ionic form. Suitable Group 9 modifiers include Group 9 elements, e.g., cobalt (Co), rhodium (Rh), iridium (Ir) and combinations thereof in any of their elemental, compound, or ionic form. Suitable Group 10 modifiers include Group 10 elements, e.g., nickel (Ni), palladium (Pd), platinum (Pt) and combinations thereof in any of their elemental, compound, or ionic form. Suitable Group 14 modifiers include Group 14 elements, e.g., germanium (Ge), tin (Sn), lead (Pb) and combinations thereof in any of their elemental, compound, or ionic form. In addition, optional Group 2 modifiers may be present, including Group 2 elements, e.g., magnesium, (Mg), Calcium (Ca), Strontium (Sr), Barium (Ba) and combinations thereof in any of their elemental, compound, or ionic form.

The modifier advantageously comprises one or more Group 10 metals. The Group 10 metal may be, e.g., platinum, palladium or a combination thereof. Platinum is a suitable Group 10 metal along with another Groups 6 to 10 and Group 14 metal in some aspects. While not limited thereto, the Groups 6 to 10 and Group 14 metal may be more narrowly selected from Pt, Pd, Ni, Re, Ru, Ir, Sn, or a combination thereof. In conjunction with Pt as a first metal in the first and/or second catalyst compositions, an optional second metal in the catalyst composition may also be more narrowly selected from the Groups 6 to 10 and Group 14 metals, such as, e.g., Pd, Ni, Re, Ru, Ir, Sn, or a combination thereof. In a more specific instance, the catalyst may comprise Pt as a Group 10 metal in an amount of 0.01-5.0 wt.% or 0.01-2.0 wt.%, or 0.1- 2.0 wt.%, more particularly 0.01-1.0 wt.% or 0.3-0.8 wt.%. An optional second metal selected from Pd, Ni, Re, Ru, Ir, Sn, or a combination thereof as a Group 6 to 10 and Group 14 metal may be present, in an amount of 0.01-5.0 wt.% or 0.01-2.0 wt.%, or 0.1-2.0 wt.%, more particularly 0.01-1.0 wt.% and 0.01- 1.5 wt.%.

The metals content in the catalyst composition may be varied over useful ranges, e.g., the total modifying metals content for the catalyst may be 0.01-5.0 wt.% or 0.01-2.0 wt.%, or 0.1-2.0 wt.% (total catalyst weight basis). In some instances, the catalyst composition comprises 0.1-2.0 wt.% Pt as one of the modifying metals and 0.01-1.5 wt.% of a second metal selected from Groups 6 to 10 and Group 14, or 0.3- 1.0 wt.% Pt and 0.03-1.0 wt.% second metal, or 0.3-1.0 wt.% Pt and 0.03-0.8 wt.% second metal. In some cases, the ratio of the first Group 10 metal to the optional second metal selected from Groups 6 to 10 and Group 14 may be in the range of 5:1 to 1:5, or 3:1 to 1:3, or 1:1 to 1:2, or 5:1 to 2:1, or 5:1 to 3:1, or 1:1 to 1:3, or 1:1 to 1:4. In more specific cases, the catalyst composition comprises 0.01 to 5.0 wt.% of the modifying metal, 1 to 99 wt.% of the matrix material, and 0.1 to 99 wt.% of the SSZ-92 molecular sieve.

The base extrudate may be made according to any suitable method. For example, the base extrudate may be made and then dried and calcined, followed by loading of any modifiers onto the base extrudate. Suitable impregnation techniques may be used to disperse the modifiers onto the base extrudate. The method of making the base extrudate is not intended to be particularly limited according to specific process conditions or techniques, however.

While not limited thereto, exemplary process conditions may include cases wherein the SSZ-92 molecular sieve, any added matrix material and any added liquid are mixed together at about 20 to 80° C. for about 0.5 to 30 min.; the extrudate is formed at about 20 to 80° C. and dried at about 90-150° C. for 0.5-8 hrs; the extrudate is calcined at 260-649° C. (500-1200° F.), in the presence of sufficient air flow, for 0.1-10 hours; the extrudate is impregnated with a modifier by contacting the extrudate with the metal impregnation solution containing at least one modifier for 0.1-10 hrs at a temperature in the range of about 20 to 80° C.; and the metal loaded extrudate is dried at about 90-150° C. for 0.1-10 hrs and calcined at 260-649° C. (500- 1200° F.), in the presence of sufficient air flow, for 0.1-10 hours.

### Process for Converting Hydrocarbons

In some embodiments the application pertains to a process for converting hydrocarbons using a catalyst comprising an SSZ-92 molecular sieve described herein. Generally, the process comprises contacting a hydrocarbonaceous feed under hydrocarbon converting conditions with a catalyst comprising the SSZ-92 molecular sieve. That is, the molecular sieve belongs to the ZSM-48 family of zeolites and the molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium. The molecular sieve has a morphology characterized as polycrystalline aggregates comprising crystallites collectively having an average aspect ratio of between 1 and 8.

There may be a number of advantages to employing SSZ-92 including, for example, at least about 1.5%, or at least about 1.8%, or at least about 2%, or at least about 2.25%, or at least about 2.5% or more better selectivity at 90% isomerization conversion than a comparable process employing a comparable catalyst such as SSZ-91 that lacks magnesium. In addition to the surprising and unexpected selectivity, processes employing SSZ-92 may provide improved lube yield (greater than about 0.3 weight percent, or greater than about 0.45 weight percent up to 1 weight percent or more), better viscosity index (at least about 1, or at least about 2 up to about 4, or up to about 5 or more), and improved gas make (reduced gas by at least about 0.2 weight percent, or at least about 0.3 weight percent up to about 0.5, or up to 1 weight percent or more) than a comparable process employing a comparable catalyst such as SSZ- 91 that lacks magnesium. Hydrocarbon feed

The hydrocarbon feed may generally be selected from a variety of base oil feedstocks, and advantageously comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof. The hydrocarbon feed may also comprise a feed hydrocarbon cut in the distillation range from 400-1300° F., or 500-1100° F., or 600-1050° F., and/or wherein the hydrocarbon feed has a KV100 (kinematic viscosity at 100° C.) range from about 3 to 30 cSt or about 3.5 to 15 cSt.

In some cases, the process may be used advantageously for a light or heavy neutral base oil feedstock, such as a vacuum gas oil (VGO), as the hydrocarbon feed where the SSZ-92 catalyst composition includes a Pt modifying metal, or a combination of Pt with another modifier.

The product(s), or product streams, may be used to produce one or more base oil products, e.g., to produce multiple grades having a KV100 in the range of about 2 to 30 cSt. Such base oil products may, in some cases, have a pour point of not more than about -12° C., or -15° C., or -20° C.

The hydroisomerization catalyst and process may also be combined with additional process steps, or system components, e.g., the feedstock may be further subjected to hydrotreating conditions with a hydrotreating catalyst prior to contacting the hydrocarbon feedstock with the hydroisomerization catalyst composition, optionally, wherein the hydrotreating catalyst comprises a guard layer catalyst comprising a refractory inorganic oxide material containing about 0.1 to 1 wt. % Pt and about 0.2 to 1.5 wt.% Pd.

In practice, hydrodewaxing is used primarily for reducing the pour point and/or for reducing the cloud point of the base oil by removing wax from the base oil. Typically, dewaxing uses a catalytic process for processing the wax, with the dewaxer feed is generally upgraded prior to dewaxing to increase the viscosity index, to decrease the aromatic and heteroatom content, and to reduce the amount of low boiling components in the dewaxer feed. Some dewaxing catalysts accomplish the wax conversion reactions by cracking the waxy molecules to lower molecular weight molecules. Other dewaxing processes may convert the wax contained in the hydrocarbon feed to the process by wax isomerization, to produce isomerized molecules that have a lower pour point than the non-isomerized molecular counterparts. As used herein, isomerization encompasses a hydroisomerization process, for using hydrogen in the isomerization of the wax molecules under catalytic hydroisomerization conditions.

Suitable hydrodewaxing conditions generally depend on the feed used, the catalyst used, desired yield, and the desired properties of the base oil. Typical conditions include a temperature of from 500° F. to 775° F. (260° C. to 413° C.); a pressure of from 300 psig to 3000 psig (2.07 MPa to 20.68 MPa gauge); a LHSV of from 0.25 hr' to 20 hr'; and a hydrogen to feed ratio of from 2000 SCF/bbl to 30,000 SCF/bbl (356 to 5340 m³ H₂/m³ feed). Generally, hydrogen will be separated from the product and recycled to the isomerization zone. Generally, dewaxing processes of the present invention are performed in the presence of hydrogen. Typically, the hydrogen to hydrocarbon ratio may be in a range from about 2000 to about 10,000 standard cubic feet H2 per barrel hydrocarbon, and usually from about 2500 to about 5000 standard cubic feet H2 per barrel hydrocarbon. The above conditions may apply to the hydrotreating conditions of the hydrotreating zone as well as to the hydroisomerization conditions of the first and second catalyst. Suitable dewaxing conditions and processes are described in, e.g., U.S. Pat. Nos. 5,135,638; 5,282,958; and 7,282,134.

While the catalyst system and process has been generally described in terms of the hydroisomerization catalyst composition comprising the SSZ-92 molecular sieve, it should be understood that additional catalysts, including layered catalysts and treatment steps may be present, e.g., including, hydrotreating catalyst(s)/steps, guard layers, and/or hydrofinishing catalyst(s)/steps

### Example Embodiments

1. A molecular sieve belonging to the ZSM-48 family of zeolites, wherein the molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium;

wherein the molecular sieve has a morphology characterized as polycrystalline aggregates comprising crystallites collectively having an average aspect ratio of between 1 and 8.

2. The molecular sieve of any preceding embodiment, wherein the molecular sieve comprises a magnesium oxide to silicon dioxide ratio of from about 0.005 to about 0.4.

3. The molecular sieve of any preceding embodiment, wherein the molecular sieve comprises a magnesium oxide to silicon dioxide ratio of from about 0.01 to about 0.25.

4. The molecular sieve of any preceding embodiment, wherein the molecular sieve comprises a magnesium oxide to silicon dioxide ratio of from about 0.04 to about 0.22.

5. The molecular sieve of any preceding embodiment, wherein the molecular sieve comprises a magnesium oxide to silicon dioxide ratio of from about 0.05 to about 0.2.

6. The molecular sieve of any preceding embodiment, wherein the molecular sieve has a silicon oxide to aluminum oxide mole ratio of 70 to 180.

7. The molecular sieve of any preceding embodiment, wherein the molecular sieve is a product of a reaction mixture comprising a molar ratio of SiO₂/Al₂O₃of from about 50 to about 220, of M/SiO₂ of from about 0.05 to about 1.0, of Q/SiO₂ of from about 0.01 to about 0.1, of OH/SiO₂ of from about 0.05 to about 0.4, and H₂O/SiO₂ of from about 3.0 to about 100 wherein M is selected from Groups 1 and 2 of the Periodic Table and Q is a hexamethonium cation.

8. The molecular sieve of any preceding embodiment, wherein the molecular sieve is a product of a reaction mixture comprising a molar ratio of SiO₂/Al₂O₃of from about 70 to about 180, of M/SiO₂ of from about 0.1 to about 0.4, of Q/SiO₂ of from about 0.015 to about 0.05, of OH/SiO₂ of from about 0.1 to about 0.3, and H₂O/SiO₂ of from about 10 to about 40 wherein M is selected from Groups 1 and 2 of the Periodic Table and Q is a hexamethonium cation.

9. The molecular sieve of any preceding embodiment, which further comprises palladium, platinum, or a mixture thereof.

10. The molecular sieve of any preceding embodiment, wherein the molecular sieve has more ammonia desorbing above 440° C. than a comparable molecular sieve lacking magnesium in an ammonia temperature programmed desorption test.

11. The molecular sieve of any preceding embodiment, wherein the molecular sieve exhibits FTIR vibrational modes at 3670 cm⁻¹, 1010 cm⁻¹, and 660 cm⁻¹.

12. The molecular sieve of any preceding embodiment, wherein the molecular sieve exhibits an FTIR vibrational mode at 3670 cm⁻¹ before and after exposure to pyridine.

13. A method of preparing the molecular sieve of any preceding embodiment, comprising: (a) preparing a reaction mixture containing at least one source of silicon, at least one source of aluminum, at least one source of an element selected from Groups 1 and 2 of the Periodic Table, at least one source of magnesium, hydroxide ions, hexamethonium cations, and water; and (b) subjecting the reaction mixture to crystallization conditions sufficient to form crystals of the molecular sieve.

14. A process for converting hydrocarbons, comprising contacting a hydrocarbonaceous feed under hydrocarbon converting conditions with a catalyst comprising a molecular sieve, the molecular sieve belonging to the ZSM-48 family of zeolites, wherein the molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium;

wherein the molecular sieve has a morphology characterized as polycrystalline aggregates comprising crystallites collectively having an average aspect ratio of between 1 and 8.

15. The process of embodiment 14 or any subsequent embodiment, wherein the molecular sieve comprises a magnesium oxide to silicon dioxide ratio of from about 0.005 to about 0.4.

16. The process of embodiment 14 or any subsequent embodiment, wherein the molecular sieve comprises a magnesium oxide to silicon dioxide ratio of from about 0.01 to about 0.25.

17. The process of embodiment 14 or any subsequent embodiment, wherein the molecular sieve comprises a magnesium oxide to silicon dioxide ratio of from about 0.04 to about 0.22.

18. The process of embodiment 14 or any subsequent embodiment, wherein the molecular sieve comprises a magnesium oxide to silicon dioxide ratio of from about 0.05 to about 0.2.

19. The process of embodiment 14 or any subsequent embodiment, wherein the molecular sieve has a silicon oxide to aluminum oxide mole ratio of 70 to 180.

20. The process of embodiment 14 or any subsequent embodiment, wherein the molecular sieve has more ammonia desorbing above 440° C. than a comparable molecular sieve lacking magnesium in an ammonia

temperature programmed desorption test and wherein the molecular sieve exhibits FTIR vibrational modes at 3670 cm⁻¹, 1010 cm⁻¹ and 660 cm⁻¹.

21. The process of embodiment 14 or any subsequent embodiment, wherein the process has at least 1.5% better selectivity at 90% isomerization conversion than a comparable process employing a comparable catalyst that lacks magnesium.

22. A method of preparing molecular sieve SSZ-92, comprising:
(a) preparing a reaction mixture containing:
   at least one active source of silicon,
   at least one active source of aluminum,
   at least one active source of magnesium,
   at least one source of an element selected from Groups 1 and 2 of the Periodic Table,
   hydroxide ions,
   hexamethonium cations, and
   water; and
(b) subjecting the reaction mixture to crystallization conditions sufficient to form crystals of the molecular sieve;

wherein the molecular sieve comprises:
a silicon oxide to aluminum oxide mole ratio of 50 to 200,
at least 70% polytype 6 of the total ZSM-48-type material present in the product, and
an additional EUO-type molecular sieve phase in an amount of between 0 and 3.5 percent by weight of the total product; and

wherein the molecular sieve has a morphology characterized as polycrystalline aggregates comprising crystallites collectively having an average aspect ratio of between 1 and 8.

23. The method of embodiment 22, wherein the molecular sieve has, in its as-synthesized form, an X-ray diffraction pattern substantially as shown in the following Table:

| | | Relative |
|---|---|---|
| 2-Theta^{(a)} | d-spacing (nm) | Intensity^{(b)} |
| 7.50 | 11.777 | w |
| 8.72 | 10.130 | vw |
| 15.06 | 5.879 | vw |
| 18.72 | 4.736 | vw |
| 21.16 | 4.195 | vs |
| 22.86 | 3.887 | vs |
| 24.56 | 3.622 | w |
| 26.14 | 3.406 | vw |
| 28.78 | 3.100 | vw |
| 31.28 | 2.857 | W |
| 34.10 | 2.627 | vw |
| 36.26 | 2.476 | vw |
| 38.04 | 2.364 | vw |
| 38.26 | 2.351 | vw |

^{(a)}±0.20
^{(b)}The powder XRD patterns provided are based on a relative intensity scale in which the strongest line in the X-ray pattern is assigned a value of 100: vw = very weak (>0 to <10); w = weak (10 to ≤20); m = medium (>20 to ≤40); s = strong (>40 to ≤60); vs = very strong (>60 to ≤100)

24. The method of embodiment 22 or any subsequent embodiment, wherein the molecular sieve is prepared from a reaction mixture comprising, in terms of mole ratios, the following:

| | |
|---|---|
| SiO₂/Al₂O₃ | 50-220 |
| M/SiO₂ | 0.05-1.0 |
| MgO/SiO₂ | 0.005-0.4 |
| Q/SiO₂ | 0.01-0.2 |
| OH/SiO₂ | 0.05-0.4 |
| H₂O/SiO₂ | 3-100 |

wherein M is selected from the group consisting of elements from Groups 1 and 2 of the Periodic Table; and Q is a hexamethonium cation.

25. The method of embodiment 22 or any subsequent embodiment or any subsequent embodiment, wherein the molecular sieve is prepared from a reaction mixture comprising, in terms of mole ratios, the following:

| | |
|---|---|
| SiO₂/Al₂O₃ | 70-180 |
| M/SiO₂ | 0.1-0.4 |
| MgO/SiO₂ | 0.01-0.25 |
| Q/SiO₂ | 0.015-0.05 |
| OH/SiO₂ | 0.10-0.3 |
| H₂O/SiO₂ | 10-40 |

wherein M is selected from the group consisting of elements from Groups 1 and 2 of the Periodic Table; and Q is a hexamethonium cation.

26. The method of embodiment 22 or any subsequent embodiment, wherein the molecular sieve has a silicon oxide to aluminum oxide mole ratio of 70 to 160.

27. The method of embodiment 22 or any subsequent embodiment, wherein the molecular sieve has a silicon oxide to aluminum oxide mole ratio of 80 to 140.

28. The method of embodiment 27, wherein the molecular sieve comprises at least 90% polytype 6 of the total ZSM-48-type material present in the product.

29. The method of embodiment 22 or any subsequent embodiment, wherein the crystallites collectively have an average aspect ratio of between 1 and 5.

30. The method of embodiment 22 or any subsequent embodiment, wherein the molecular sieve comprises between 0.1 and 2 wt.% EU-1.

31. The method of embodiment 22 or any subsequent embodiment, wherein the molecular sieve comprises at least 80% polytype 6 of the total ZSM-48-type material present in the product.

32. The method of embodiment 31, wherein the crystallites collectively have an average aspect ratio of between 1 and 5.

33. The method of embodiment 32, wherein the molecular sieve comprises between 0.1 and 2 wt.% EU-1.

34. The method of embodiment 31, wherein the molecular sieve comprises between 0.1 and 2 wt.% EU-1.

35. The method of embodiment 22 or any subsequent embodiment, wherein the molecular sieve comprises at least 90% polytype 6 of the total ZSM-48-type material present in the product.

36. The method of embodiment 35, wherein the crystallites collectively have an average aspect ratio of between 1 and 5.

37. The method of embodiment 36, wherein the molecular sieve comprises between 0.1 and 2 wt.% EU-1.

38. The method of embodiment 15, wherein the molecular sieve comprises between 0.1 and 2 wt.% EU-1.

39. The method of embodiment 22 or any subsequent embodiment, wherein the crystallites collectively have an average aspect ratio of between 1 and 5.

40. The method of embodiment 39, wherein the molecular sieve comprises at least 90% polytype 6 of the total ZSM-48-type material present in the product.

41. The method of embodiment 22 or any subsequent embodiment, wherein the crystallites collectively have an average aspect ratio of between 1 and 3.

Example 1 (Comparative)

An example of SSZ-91, a product without magnesium oxide was prepared.

A reaction mixture for a 1-gallon was prepared by adding in sequence to a total of 1446.97 g of de-ionized water the following: 48.29 g of 50% aqueous NaOH, 25.79g of Hexamethonium bromide, 6.4 g of Anhydrous, Sodium Aluminate (Riedel de Haen), 220.0 g of Cabosil M-5, and 52.51 g of SSZ-91 slurry seed. The molar ratios of the reaction mixture components were as follows:

| Components | Molar ratio |
|---|---|
| SiO₂/Al₂O₃ | 113.6 |
| H₂O/SiO₂ | 23.0 |
| OH−/SiO₂ | 0.17 |
| Na+/SiO₂ | 0.17 |
| Org/SiO₂ | 0.02 |
| % seed | 2.92% |

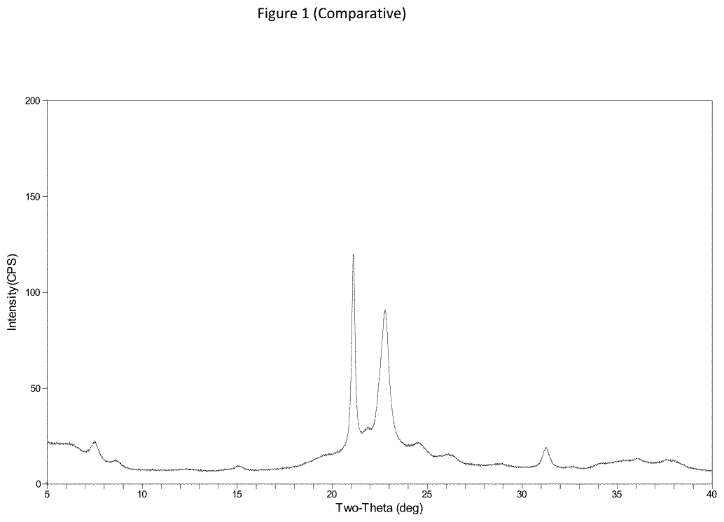

The reaction mixture was heated to 160° C. over a period of 8 hours and continuously stirred at 150 rpm from 48 to 72 hours. The product was filtered, washed with deionized water and dried at 95° C. (203° F.). The as-synthesized product was determined by XRD powder diffraction (FIG. 1) to have pure MRE type structure.

The as-synthesized product was converted into the ammonium form by first calcining in air at 595° C. for 5 hours followed by two ion exchanges with ammonium nitrate solution at 95° C. for 4 hours and dried at 95° C. (203° F.). Al, Na, and Si analysis by ICP of the resulting ammonium form revealed 0.807%, 0.009%, and 43.0% respectively having SiO₂/Al₂O₃ molar ratio of 102, micropore volume of 0.069 cc/g, external surface area of 99 m²/g and BET surface area of 248 m²/g.

Example 2

A reaction mixture for a 1-gallon of SSZ-92 was prepared by adding in sequence to a total of 1446.96g of de-ionized water the following: 48.30g of 50% aqueous NaOH, 25.50g of Hexamethonium bromide, 6.40g of Anhydrous, Sodium Aluminate (Riedel de Haen), 220.02g of Cabosil M-5, 52.82g of SSZ-91 slurry seed and finally Magnesium Oxide. The molar ratios of the reaction mixture components were as follows:

| Components | Molar ratio |
|---|---|
| SiO₂/Al₂O₃ | 113.6 |
| H₂O/SiO₂ | 26.0 |
| OH−/SiO₂ | 0.17 |
| Na+/SiO₂ | 0.17 |
| Org/SiO₂ | 0.02 |
| MgO/SiO₂ | 0.08 |
| % seed | 2.63% |

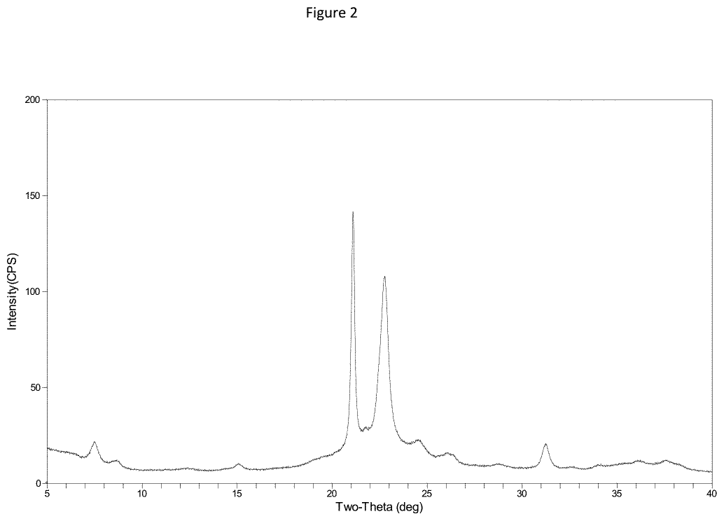

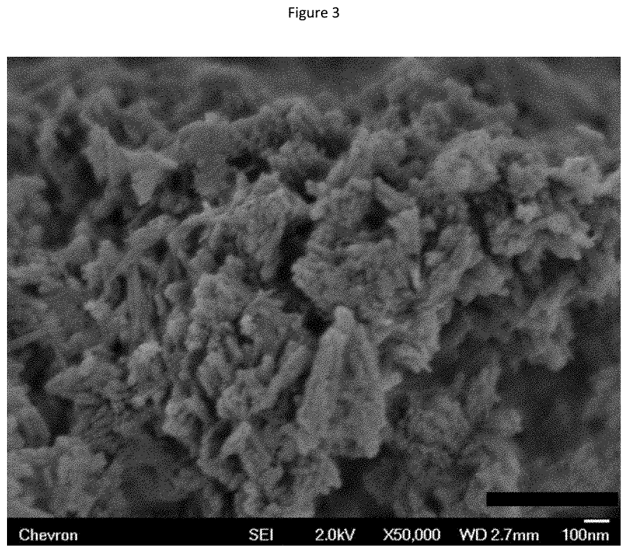

The reaction mixture was heated to 160° C. over a period of 8 hours and continuously stirred at 150 rpm from 48 to 72 hours. The product was filtered, washed with deionized water and dried at 95° C. (203° F.). The as-synthesized product was determined by XRD powder diffraction (FIG. 2) to have pure MRE type structure. The SEM (FIG. 3) of the as-synthesized product showed that the product was composed of agglomerated particles with average crystal size of <500 nm. Analysis of Al, Na, Si and Mg by ICP revealed 0.784%, 0.189%, 35.7% and 2.93% respectively having Mg/Si molar ratio of 0.095 and SiO₂/Al₂O₃ molar ratio of 87.

The as-synthesized product was converted into the ammonium form by first calcining in air at 595° C. for 5 hours followed by two ion exchanges with ammonium nitrate solution at 95° C. for 4 hours and dried at 95° C. (203° F.). The resulting ammonium product contained 2.73% Mg with Mg/Si molar ratio of 0.086, SiO₂/Al₂O₃ molar ratio of 81, micropore volume of 0.06 cc/g, external surface area of 134 m²/g and BET surface area of 266 m²/g. Example 3

A reaction mixture for a 1-gallon of SSZ-92 was prepared by adding in sequence to a total of 1622.04g of de-ionized water the following: 42.98g of 50% aqueous NaOH, 22.97g of Hexamethonium bromide, 5.7g of Anhydrous, Sodium Aluminate (Riedel de Haen), 220.02g of 195.81g of Cabosil M-5, 54.0g of SSZ-91 slurry seed and finally 19.7g of Magnesium Oxide.

The molar ratios of the reaction mixture components were as follows:

| Components | Molar ratio |
|---|---|
| SiO₂/Al₂O₃ | 113.7 |
| H₂O/SiO₂ | 28.7 |
| OH−/SiO₂ | 0.17 |
| Na+/SiO₂ | 0.17 |
| Org/SiO₂ | 0.02 |
| MgO/SiO₂ | 0.15 |
| % seed | 2.75% |

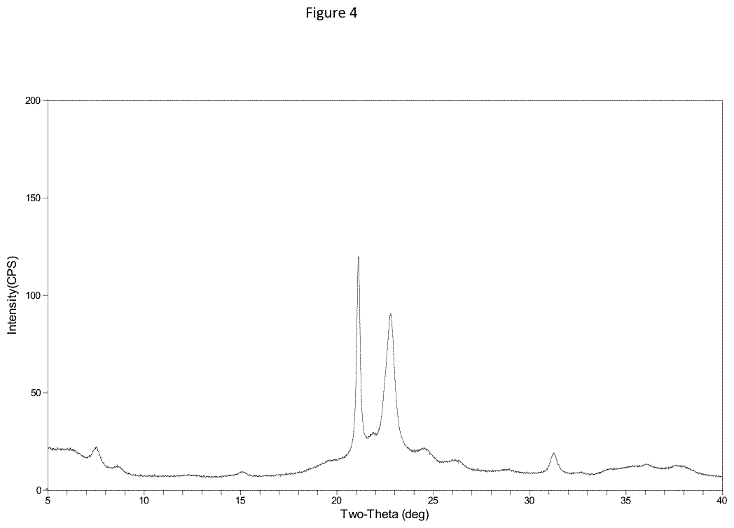

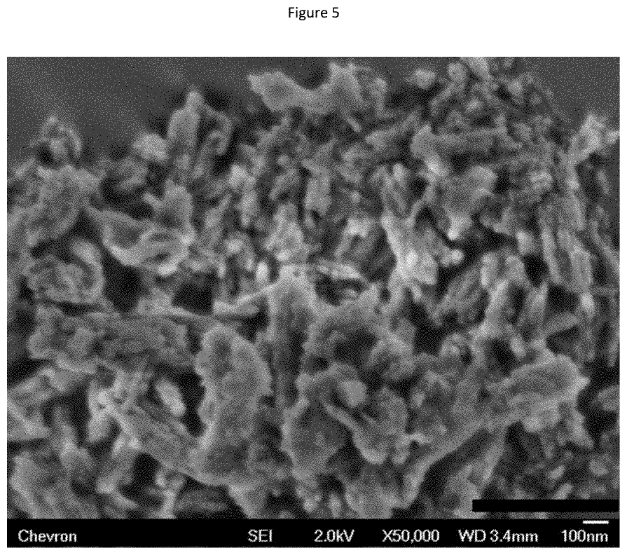

The reaction mixture was heated to 160° C. over a period of 8 hours and continuously stirred at 150 rpm from 48 to 72 hours. The product was filtered, washed with deionized water and dried at 95° C. (203° F.). The as-synthesized product was determined by XRD powder diffraction (FIG. 4) to have pure MRE type structure. The SEM of the as-synthesized product (FIGS. 5) showed the product was composed of agglomerated particles with average crystal size of <500 nm.

The as-synthesized product was converted into the ammonium form by first calcining in air at 595° C. for 5 hours followed by two ion exchanges with ammonium nitrate solution at 95° C. for 4 hours and dried at 95° C. (203° F.). Al, Na, Si and Mg analysis by ICP of the resulting ammonium form revealed 0.827%, 0.006%, 37.1% and 5.05% respectively having Mg/Si molar ratio of 0.157, SiO₂/Al₂O₃ molar ratio of 86, micropore volume of 0.067 cc/g, external surface area of 154 m²/g and BET surface area of 299 m²/g.

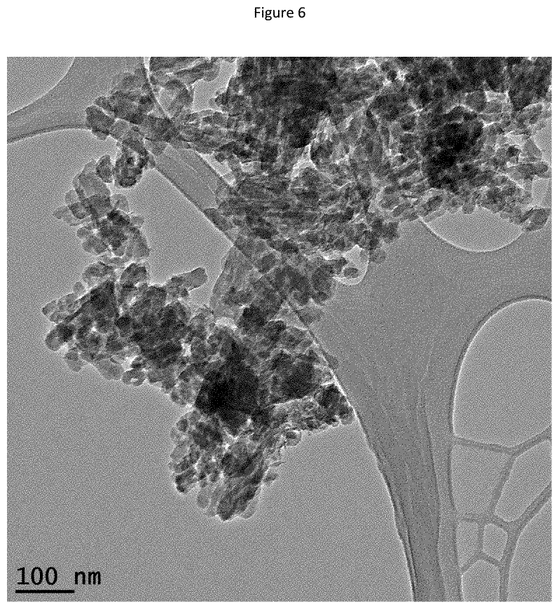

This ammonium exchanged zeolite was analyzed by Transmission Electron Microscopy (TEM) and shown in FIG. 6. Methods for TEM measurement are disclosed by A. W. Burton et al. in Microporous Mesoporous Mater. 117, 75-90, 2009 which is incorporated herein by reference. The results showed that the product was uniformly distributed SSZ-92 small crystals.

Characterization of acidity

Experimental Procedure 1

Ammonia temperature programmed desorption (NH₃ TPD) experiments were performed on an Autochem II system (Micromeritics, Inc.). The TPD profiles and peak maximum temperatures are sensitive to the ratio of sample mass and gas flowrate; therefore, analyses were conducted with 300 mg pelletized, crushed and sieved giving 25-60 mesh particles. Samples were dried by heating in 50 sccm Ar at 500 ° C. for 3 h with a temperature increase rate of 10 ° C./min. Samples were then cooled to 120 ° C. and exposed to a flowing stream of 25 sccm 5% NH₃/Ar for 0.5 h, then the flow was changed to 50 sccm Ar to desorb weakly bound NH₃ for 3 h. The temperature was increased to 500 ° C. at a rate of 10 ° C./min and held at 500 ° C. for 1 h.

Experimental Procedure 2

Vibrational spectra were measured using a Nicolet 6700 FTIR spectrometer. Zeolites were pressed into thin, self-supporting wafers (5-10 mg/cm²) and dehydrated in vacuum at 450 ° C. for 1 hr in a steel cell with CaF windows. Spectra were recorded at 80 ° C. in transmission mode with MCTB detector with 128 scans from 400 cm⁻¹ to 4000 cm⁻¹. Framework modes were recorded between 300 cm⁻¹ to 4000 cm⁻¹ using single-reflection diamond-ATR and DTGS detector.

Experimental Procedure 3

Acid site concentration measurements were performed on a TGA microbalance (Q5000IR, TA Instruments) using about 20 mg of sample. Materials were dried by heating in 25 sccm N₂ to 500 ° C. at 5 ° C./min and held for 1 hr. Samples were cooled to 120 ° C. and exposed to isopropyl amine (IPAM) by flowing N₂ through a room temperature bubbler and then passing the IPAM/N₂ stream over the sample for 10 min. The gas flow was then changed to pure N₂ to remove weakly bound IPAM, followed by a temperature programmed desorption in N₂ to a maximum temperature of 500 ° C. for 1 hr at a rate of 10 ° C./min. There were two major desorptions from 1) physisorbed IPAM and 2) from IPAM adsorbed on Brødnsted acid sites within the zeolite framework. The area of the high temperature peak, corresponding to the Brødnsted acid sites, was used to estimate the acid site concentration.

Example 4

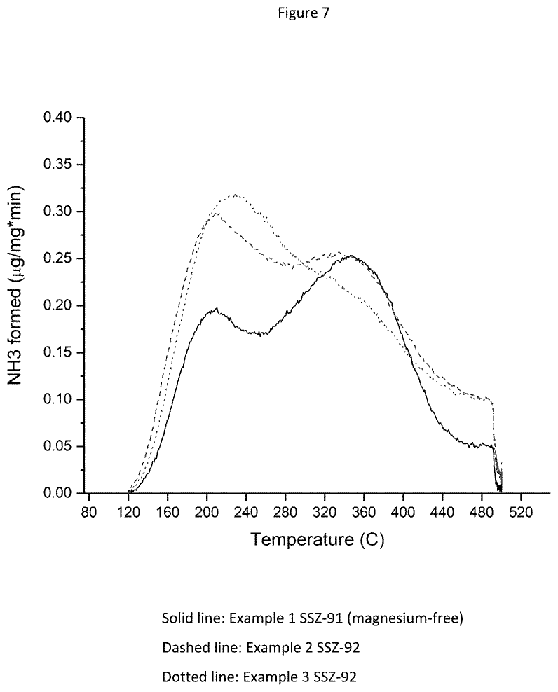

NH₃ TPD on samples from Example 1 SSZ-91, Example 2 SSZ-92 and Example 3 SSZ-92 were measured as per experimental Procedure 1. Desorption profiles are shown in FIG. 7 wherein Solid line is Example 1 SSZ-91 (magnesium-free) and dashed line is Example 2 SSZ-92 and dotted line is Example 3 SSZ-92.

The peaks are overlapping; therefore, it is not straightforward to describe the relative sizes of the low and high temperature peaks. Two maxima are present in Example 1; a peak near 200 ° C. and another centered from 340 ° C. The high temperature peak arises from strong acid sites (Ref. book chapter by Auroux, Aline, Ch. 3, in A.W. Chester, E.G. Derouane (eds.), Zeolite Characterization and Catalysis, p. 107- 166, Springer Science and Business Media, 2009) which is incorporated herein by reference. In Example 3, containing 5.05% Mg, which also had two maxima, the first peak occurred at 220 ° C. and the second at 340 ° C. The profile for sample Example 2, which contained 2.73% Mg, has a low temperature peak at 200 ° C. and a high temperature peak at 340 ° C. Both samples that contained magnesium had low temperature peak that was larger than the magnesium-free Example 1. The intensity of the low temperature peak increased with increasing magnesium concentration. The maximum of the high temperature peak occurs at a temperature that is almost unchanged in all samples; all three samples were centered near 340 ° C. The samples containing magnesium, SSZ-92, Example 2 and Example 3, also have more ammonia desorbing above 440 ° C. than the magnesium-free Example 1.

Example 5

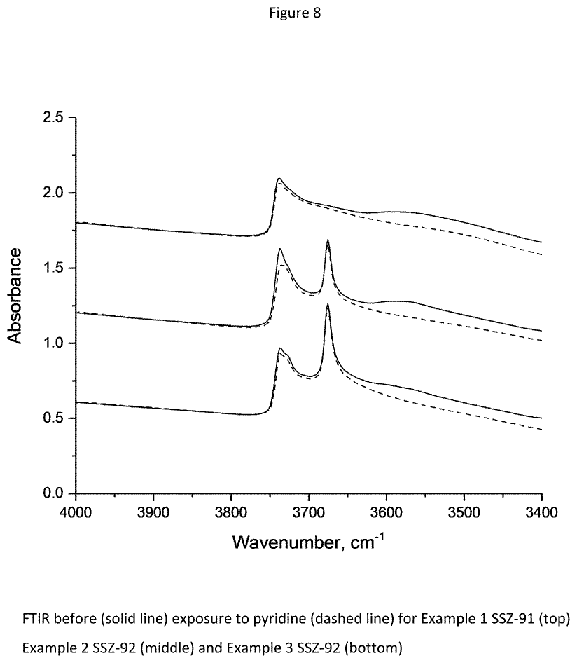

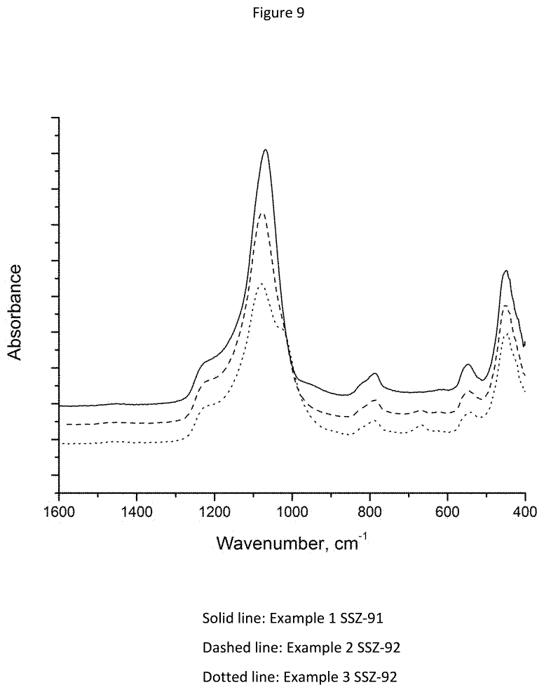

Infrared spectra of Example 1, Example 2 and Example 3 are provided in FIGS. 8 and 9. The 3740 cm⁻¹ mode is from non-acidic SiOH groups in the material, and the 3600 cm⁻¹ mode represents acidic Si-OH-Al groups. The samples contained acidities, shown in Table 1 in the range of 0.24-0.28 mmol/g, as measured using Experimental Procedure 3.

TABLE 1
Brønsted acidities of
materials calculated by
isopropylamine titration

| | IPAM |
|---|---|
| | Desorption, |
| Material | mmol/g |
| Example 1 | 0.28 |
| Example 2 | 0.24 |
| Example 3 | 0.24 |

Magnesium-containing materials, SSZ-92 Example 2 and Example 3 had a vibrational mode at 3670 cm-1 that was not observed in Example 1. This mode did not disappear when exposed to pyridine (FIG. 8). FIG. 8 shows FTIR before (solid line) exposure to pyridine (dashed line) for Example 1 SSZ-91 (top), Example 2 SSZ-92 (middle) and Example 3 SSZ-92 (bottom).

While not wishing to be bound to be any specific theory, the band may be caused by Mg-OH in the material because it was not observed in magnesium-free Example 1. Example 2 and Example 3 also showed modes in the fingerprint region at 660 cm⁻¹ and 1010 cm⁻¹ not present in magnesium-free Example 1 (FIG. 9). FIG. 9 shows ATR-IR spectra wherein solid line is Example 1 SSZ-91, dashed line is Example 2 SSZ-92 and dotted line is Example 3 SSZ-92.

CATALYST PREPARATION AND EVALUATION

Hydroprocessing Tests: n-Hexadecane Isomerization

Example 6

Palladium ion exchange was carried out for the ammonium exchanged forms from Examples 1-3 with palladiumtetraamine dinitrate (0.5 wt% Pd). After ion exchange, the samples were dried at 95° C. (203° F.) and then calcined in air at 482 ° C. for 3 hours to convert the palladiumtetraamine dinitrate to palladium oxide.

0.5 g of each of the palladium exchanged samples from Examples 1-3 was loaded in the center of a 23 inch-long by 0.25 inch outside diameter stainless steel reactor tube with alundum loaded upstream of the catalyst for pre-heating the feed (total pressure of 1200 psig; down-flow hydrogen rate of 160 mL/min (when measured at 1 atmosphere pressure and 25° C.); down-flow liquid feed rate of 1 mL/hour. All materials were first reduced in flowing hydrogen at about 315° C. for 1 hour. Products were analyzed by on-line capillary gas chromatography (GC) once every thirty minutes. Raw data from the GC was collected by an automated data collection/processing system and hydrocarbon conversions were calculated from the raw data.

The catalyst was tested at about 260° C. initially to determine the temperature range for the next set of measurements. The overall temperature range will provide a wide range of hexadecane conversion with the maximum conversion just below and greater than 96%. At least five on-line GC injections were collected at each temperature. Conversion was defined as the amount of hexadecane reacted to produce other products (including iso-n-C₁₆ isomers). Isomerization selectivity is expressed as weight percent of products other than n-C₁₆ and included iso-C₁₆ as a yield product. The catalytic results are included in Table 2.

The best catalytic performance is dependent on the synergy between isomerization selectivity and temperature at 96% conversion. A good balance between isomerization selectivity and temperature at 96% conversion is critical for this invention. The isomerization selectivity at 96% conversion for the magnesium-containing zeolite SSZ-92 described in this invention is better than that without Magnesium. The desirable C_{4—} cracking for the materials of this invention is below 1.2%.

TABLE 2
n-Hexadecane Isomerization selectivity
and temperatures at 96% Conversion

| | Example 1 | | |
|---|---|---|---|
| Examples | Comparative | Example 2 | Example 3 |
| Selectivity % | 87% | 89% | 90% |
| Temperature ° F. | 558 | 581 | 590 |
| C₄₋ Cracking | 1.3% | 1.1% | 1.0% |

Example 7

A comparative hydroisomerization Catalyst A was prepared as follows: Example 1 was composited with Catapal alumina to provide a mixture containing 65 wt.% SSZ-91 zeolite. The mixture was extruded, dried, and calcined, and the dried and calcined extrudate was impregnated with a solution containing platinum. The overall platinum loading was 0.6 wt.%.

Hydroisomerization catalyst B was prepared as described for Catalyst A to provide a mixture containing 65 wt.% Example 3 SSZ-92 and 35 wt. % Catapal alumina. The dried and calcined extrudate was impregnated with platinum to provide an overall platinum loading of 0.6 wt.%.

Hydroisomerization performance test conditions

A waxy feed “light neutral” (LN) was used to evaluate the invented catalysts. Properties of the feed are listed in the following Table 3.

TABLE 3

| | Value |
|---|---|
| VGO Feedstock Property | |
| gravity, °API | 34 |
| Sulfur content, wt. % | 6 |
| viscosity index at 100° C. (cSt) | 3.92 |
| viscosity index at 70° C. (cSt) | 7.31 |
| Wax content, wt. % | 12.9 |
| SIMDIST Distillation | |
| Temperature | |
| (wt. %), ° F. (° C.) | |
| 0.5 | 536 (280) |
| 5 | 639 (337) |
| 10 | 674 (357) |
| 30 | 735 (391) |
| 50 | 769 (409) |
| 70 | 801 (427) |
| 90 | 849 (454) |
| 95 | 871 (466) |
| 99.5 | 910 (488) |

The reaction was performed in a micro unit equipped with two fix bed reactors. The run was operated under 2100 psig total pressure. The feed was passed through the hydroisomerization reactor installed with Catalyst A or B at a liquid hourly space velocity (LHSV) of 2, and then was hydrofinished in the 2nd reactor loaded with a hydrofinishing catalyst to further improve the lube product quality. The hydrofinishing catalyst is composed of Pt, Pd and a support. The hydroisomerization reaction temperature was adjusted in the range of 580-680 ° F. to reach -15 ° C. The hydrogen to oil ratio was about 3000 scfb. The lube product was separated from fuels through a distillation section.

The test results are listed in Table 4. It is demonstrated that Catalyst B has improved lube yield and viscosity index. Correspondingly, the gas make was reduced by 0.3 wt.%.

TABLE 4

| Tests | Catalyst A | Catalyst B |
|---|---|---|
| Lube yield (wt. %) | Base | +0.5 |
| Gas (wt. %) | Base | −0.3 |
| Viscosity Index | Base | +2.0 |

The present disclosure is not to be limited in terms of the particular embodiments described in this application, which are intended as illustrations of various aspects. Many modifications and variations can be made without departing from its spirit and scope, as may be apparent. Functionally equivalent methods and systems within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise, various steps may be omitted, repeated, or combined, as necessary, to achieve the same or similar objectives. Accordingly, the invention is not limited to the above- described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

What is claimed is:

1. A molecular sieve belonging to the ZSM-48 family of zeolites, wherein the molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium;
wherein the molecular sieve has a morphology characterized as polycrystalline aggregates comprising crystallites collectively having an average aspect ratio of between 1 and 8.

2. The molecular sieve of claim 1, wherein the molecular sieve comprises a magnesium oxide to silicon dioxide ratio of from about 0.005 to about 0.4.

3. The molecular sieve of claim 1, wherein the molecular sieve comprises a magnesium oxide to silicon dioxide ratio of from about 0.01 to about 0.25.

4. The molecular sieve of claim 1, wherein the molecular sieve comprises a magnesium oxide to silicon dioxide ratio of from about 0.04 to about 0.22.

5. The molecular sieve of claim 1, wherein the molecular sieve comprises a magnesium oxide to silicon dioxide ratio of from about 0.05 to about 0.2.

6. The molecular sieve of claim 1, wherein the molecular sieve has a silicon oxide to aluminum oxide mole ratio of 70 to 180.

7. The molecular sieve of claim 1, wherein the molecular sieve is a product of a reaction mixture comprising a molar ratio of SiO₂/Al₂O₃of from about 50 to about 220, of M/SiO₂ of from about 0.05 to about 1.0, of Q/SiO₂ of from about 0.01 to about 0.1, of OH/SiO₂ of from about 0.05 to about 0.4, and H₂O/SiO₂ of from about 3.0 to about 100 wherein M is selected from Groups 1 and 2 of the Periodic Table and Q is a hexamethonium cation.

8. The molecular sieve of claim 1, wherein the molecular sieve is a product of a reaction mixture comprising a molar ratio of SiO₂/Al₂O₃of from about 70 to about 180, of M/SiO₂ of from about 0.1 to about 0.4, of Q/SiO₂ of from about 0.015 to about 0.05, of OH/SiO₂ of from about 0.1 to about 0.3, and H₂O/SiO₂ of from about 10 to about 40 wherein M is selected from Groups 1 and 2 of the Periodic Table and Q is a hexamethonium cation.

9. The molecular sieve of claim 1, which further comprises palladium, platinum, or a mixture thereof.

10. The molecular sieve of claim 1, wherein the molecular sieve has more ammonia desorbing above 440° C. than a comparable molecular sieve lacking magnesium in an ammonia temperature programmed desorption test.

11. The molecular sieve of claim 1, wherein the molecular sieve exhibits FTIR vibrational modes at 3670 cm⁻¹, 1010 cm⁻¹, and 660 cm⁻¹.

12. The molecular sieve of claim 1, wherein the molecular sieve exhibits an FTIR vibrational mode at 3670 cm⁻¹⁻ before and after exposure to pyridine.

13. A method of preparing the molecular sieve of claim 1, comprising: (a) preparing a reaction mixture containing: at least one source of silicon, at least one source of aluminum, at least one source of an element selected from Groups 1 and 2 of the Periodic Table, at least one source of magnesium, hydroxide ions, hexamethonium cations, and water; and (b) subjecting the reaction mixture to crystallization conditions sufficient to form crystals of the molecular sieve.

14. A process for converting hydrocarbons, comprising contacting a hydrocarbonaceous feed under hydrocarbon converting conditions with a catalyst comprising a molecular sieve, the molecular sieve belonging to the ZSM-48 family of zeolites, wherein the molecular sieve comprises: a silicon oxide to aluminum oxide mole ratio of 50 to 220, at least 70% polytype 6 of the total ZSM-48-type material present in the product, an additional EUO-type molecular sieve phase in an amount of between 0 and 3.5 percent by weight of the total product, and magnesium;
wherein the molecular sieve has a morphology characterized as polycrystalline aggregates comprising crystallites collectively having an average aspect ratio of between 1 and 8.

15. The process of claim 14, wherein the molecular sieve comprises a magnesium oxide to silicon dioxide ratio of from about 0.005 to about 0.4.

16. The process of claim 14, wherein the molecular sieve comprises a magnesium oxide to silicon dioxide ratio of from about 0.01 to about 0.25.

17. The process of claim 14, wherein the molecular sieve comprises a magnesium oxide to silicon dioxide ratio of from about 0.04 to about 0.22.

18. The process of claim 14, wherein the molecular sieve comprises a magnesium oxide to silicon dioxide ratio of from about 0.05 to about 0.2.

19. The process of claim 14, wherein the molecular sieve has a silicon oxide to aluminum oxide mole ratio of 70 to 180.

20. The process of claim 14, wherein the molecular sieve has more ammonia desorbing above 440° C. than a comparable molecular sieve lacking magnesium in an ammonia temperature programmed desorption test and wherein the molecular sieve exhibits FTIR vibrational modes at 3670 cm⁻¹, 1010 cm⁻¹ and 660 cm⁻¹.

21. The process of claim 14, wherein the process has at least 1.5% better selectivity at 90% isomerization conversion than a comparable process employing a comparable catalyst that lacks magnesium.

22. A method of preparing molecular sieve SSZ-92, comprising:
(a) preparing a reaction mixture containing:
at least one active source of silicon,
at least one active source of aluminum,
at least one active source of magnesium,
at least one source of an element selected from Groups 1 and 2 of the Periodic Table,
hydroxide ions,
hexamethonium cations, and
water; and
(b) subjecting the reaction mixture to crystallization conditions sufficient to form crystals of the molecular sieve;
wherein the molecular sieve comprises:
a silicon oxide to aluminum oxide mole ratio of 50 to 200,
at least 70% polytype 6 of the total ZSM-48-type material present in the product, and
an additional EUO-type molecular sieve phase in an amount of between 0 and 3.5 percent by weight of the total product; and
wherein the molecular sieve has a morphology characterized as polycrystalline aggregates comprising crystallites collectively having an average aspect ratio of between 1 and 8.

23. The method of claim 22, wherein the molecular sieve has, in its as-synthesized form, an X-ray diffraction pattern substantially as shown in the following Table:

| | | Relative |
|---|---|---|
| 2-Theta^{(a)} | d-spacing (nm) | Intensity^{(b)} |
| 7.50 | 11.777 | w |
| 8.72 | 10.130 | vw |
| 15.06 | 5.879 | vw |
| 18.72 | 4.736 | vw |
| 21.16 | 4.195 | vs |
| 22.86 | 3.887 | vs |
| 24.56 | 3.622 | w |
| 26.14 | 3.406 | vw |
| 28.78 | 3.100 | vw |
| 31.28 | 2.857 | w |
| 34.10 | 2.627 | vw |
| 36.26 | 2.476 | vw |
| 38.04 | 2.364 | vw |
| 38.26 | 2.351 | vw |

^{(a)}±0.20
^{(b)}The powder XRD patterns provided are based on a relative intensity scale in which the strongest line in the X-ray pattern is assigned a value of 100: vw = very weak (>0 to <10); w = weak (10 to ≤20); m = medium (>20 to ≤40); s = strong (>40 to ≤60); vs = very strong (>60 to ≤100)

24. The method of claim 22, wherein the molecular sieve is prepared from a reaction mixture comprising, in terms of mole ratios, the following:

| | |
|---|---|
| SiO₂/Al₂O₃ | 50-220 |
| M/SiO₂ | 0.05-1.0 |
| MgO/SiO₂ | 0.005-0.4 |
| Q/SiO₂ | 0.01-0.2 |
| OH/SiO₂ | 0.05-0.4 |
| H₂O/SiO₂ | 3-100 |

wherein M is selected from the group consisting of elements from Groups 1 and 2 of the Periodic Table; and
Q is a hexamethonium cation.
